(19) United States
(12) Patent Application Publication
(10) Pub. No.: US 2006/0086572 A1
(43) Pub. Date: Apr. 27, 2006

(54) Tree ladder

(76) Inventor: James A. Martin, Rockwood, TN (US)

Correspondence Address: PITTS AND BRITTIAN P C, P O BOX 51295, KNOXVILLE, TN, 37950-1295, US

(21) Appl. No.: 10/970,545

(22) Filed: Oct. 21, 2004

(51) Int. Cl. E06C 1/52

(52) U.S. Cl. 182/196

(57) ABSTRACT

A ladder includes a hook segment having an outboard end including a receiver. A first cable segment is secured to said hook segment and a second cable segment is secured to the hook segment. A plurality of elongated rungs includes a bottom rung and at least an uppermost intermediate rung. Each of the rungs includes a first end section including a receiver and an opposed second end section including an extension adapted to releasably engage the receiver of an adjacent rung. The uppermost rung includes an extension adapted to releasably engage the receiver of the hook segment. Each of the first end sections of the rungs is secured to the first cable segment and each of the second end sections is secured to the second cable segment.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to ladders.

More particularly, this invention pertains to collapsible ladders for attachment to a branch located a substantial height above the reach of a user.

2. Description of the Related Art

In the field of hunting, it is frequently desirable for a hunter to climb high into a tree and sit in a tree stand to watch for game. Many different types of equipment have been provided to assist in climbing trees. For example, small sections of rigid ladders have been sequentially attached to a tree. However, these ladder sections are bulky and heavy, and therefore not useful when a hunter must travel substantial distances on foot. Also, the ladder sections require the hunter to attach a first section while standing on the ground and then stand on the attached section while attaching the next higher section. This can be dangerous in that the hunter can easily fall while climbing or attaching the ladder.

It is an object of the present invention to provide a tree ladder that is lightweight and compact for ease of transport. It is also an object of the present invention to provide a tree ladder that can be assembled to reach a tree branch substantially greater than the height of the user.

### BRIEF SUMMARY OF THE INVENTION

According to one embodiment of the present invention, a ladder includes a plurality of elongated rungs, including a top rung and a bottom rung. Each of the rungs includes a first end section and a second end section. The first end section of each of the rungs is secured to a first flexible cable segment. The second end section of each of the rungs is secured to a second flexible cable segment. The second end section of each of the rungs, except the top rung, releasably engages the first end section of an adjacent rung to cooperatively define an elongated pole. The second end section of the top rung releasably engages a hook segment. In storage position, the rungs and hook segment are bundled together in a generally parallel condition, surrounded by a strap or other circumferential binder. After release from the strap or binder, the rungs are assembled into a generally co-linear arrangement to define a pole. The hook segment is engaged with the top end of the pole. The user then raises the hook and pole up into the tree to set the hook segment over the desired branch. Upon release by the user, the rungs disengage, to fall into vertically sequential and generally parallel positions, suspended by the first and second flexible cable segments. As desired, the ground level rung may be attached to the tree or ground to resist swaying.

In order to remove the ladder from the branch after use, a rope or other flexible cable may be attached to the hook to assist the user on the ground to lift the hook up and over the branch. The ladder is allowed to fall to the ground.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a tree ladder embodying various features of the present invention in an expanded position.

FIG. 2 is a perspective view of the tree ladder of FIG. 1, in an assembled position.

### DETAILED DESCRIPTION OF THE INVENTION

A compact apparatus for assembly into a hooked pole, which can reach a height substantially higher than the user, hook onto a branch of a tree and then disengage to provide a scalable ladder is disclosed.

Referring to the drawings, in which in which like reference numbers refer to like parts, a lightweight, compact apparatus for assembly into a hooked pole, which can reach a height substantially higher than the user, hook onto a branch of a tree and then disengage to provide a scalable ladder is disclosed.

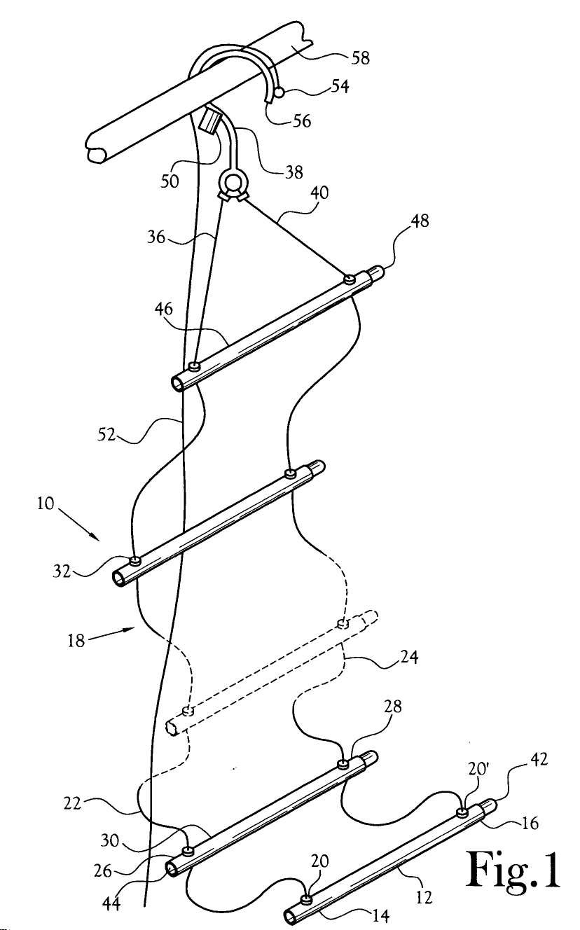

Referring to FIG. 1, an unassembled tree ladder 10 includes an elongated bottom rung 12, defining a first end section 14 and an opposing second end section 16. A flexible cable 18, which may comprise braided steel, for example, is threaded through apertures defined in the bottom rung 12, extending along the bottom surface of the bottom rung 12. The cable 18 is secured to the first end section 14 and the second end section 16 of the bottom rung 12 with crimped ferrules 20 and 20′, respectively.

The first cable segment 22 is threaded through apertures defined in each first end section 26 of a plurality of intermediate rungs 30. A crimped top ferrule 32 and a crimped bottom ferrule 34 secure the first cable segment 22 to each of the intermediate rungs 30. The top end 36 of the first cable segment 22 is secured to a hook segment 38, as with crimped ferrules, for example. The lengths of cable segment 22 extending between the bottom rung 12 and the first intermediate rung 30 and between each of the intermediate rungs 30 are greater than the lengths of the rungs.

Similarly, the second cable segment 24 is threaded through apertures defined in each second end section 28 of the plurality of intermediate rungs 30. A crimped top ferrule 32 and a crimped bottom ferrule 34 secure the first cable segment 22 to each of the intermediate rungs 30. The top end 40 of the second cable segment 24 is secured to the hook segment 38, as with crimped ferrules, for example. The lengths of cable segment 24 extending between the bottom rung 12 and the first intermediate rung 30 and between each of the intermediate rungs 30 are similar to the lengths of the first cable segments extending between corresponding rungs.

The second end section 16 of the bottom rung 12 includes a coaxial male extension 42 adapted to releasably engage a female receiver 44 defined in the first end section 26 of the first intermediate rung 30 adjacent to the bottom rung 12. Similarly, each of the second end sections 28 of the intermediate rungs 30 includes a coaxial male extension 42 adapted to releasably engage a female receiver 44 defined in the adjacent intermediate rung 30. The uppermost rung 46 includes a coaxial male extension 48 adapted to releasably engage a female receiver 50 defined in the hook segment 38.

The rungs 12, 30 and 46 and the hook segment 38 are preferably formed from rigid aluminum tubing, fiberglass, carbon fiber or any lightweight material having the strength and rigidity to support the weight of a user.

A flexible cable 52, such as twine or rope, is secured to a ring 54 located near the outboard end 56 of the hook segment 38.

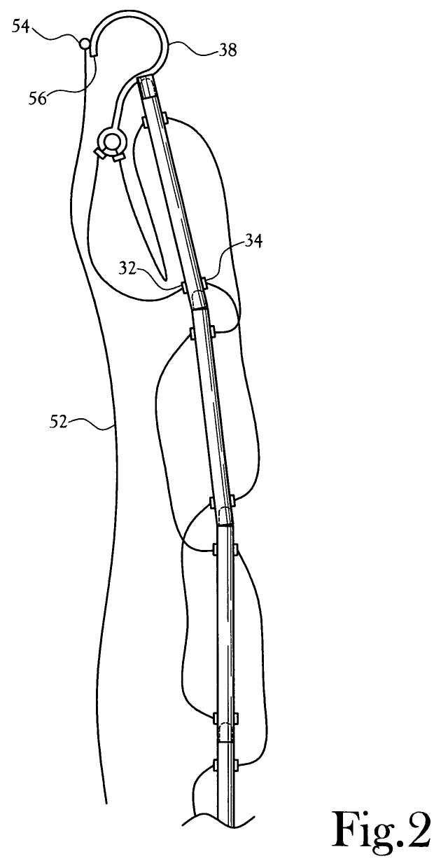

In use, the tree ladder is stored and transported in a compact and lightweight bundle, with all of the rungs 12, 30 and 46 and the hook segment 38 generally parallel to one another. A strap may be used to contain them or they may be contained is a bag. Upon arrival at the tree to be scaled, the male extension of the uppermost intermediate rung 46 is releasably inserted into the female receiver 50 of the hook segment 38. The male extension 42 of each intermediate rung 30 is inserted into the female receiver 44 of the next higher intermediate rung 30 and the male extension 42 of the bottom rung 12 is releasably inserted into the female extension of the female receiver 44 defined in the adjacent intermediate rung 30. In this manner a temporary pole structure, as partially depicted in FIG. 2, is defined by the rungs 12, 30 and 46 and the hook segment 38. The operator then lifts the pole up into the tree, substantially above his head, to extend the hook segment 38 over the desired branch 58. The rope 52 also extends over the branch 58. Thereafter, the operator releases the bottom rung 12 and each of the male extensions 42 and 48 disengages from the respective female receiver. The force of gravity cause all of the rungs to fall into vertically sequential and generally parallel positions, suspended by the first and second flexible cable segments 22 and 24. As desired, the bottom rung may be attached to the tree or ground to resist swaying. The operator may now climb the ladder to a desired branch of the tree.

When the operator has completed the desired activity in the tree, he descends the ladder and, by pulling on the rope 52, lifts the outboard end 56 of the hook segment 38 up and over the branch 58 and allows the ladder to fall to the ground for additional use or bundling for transport and storage.

Those skilled in the art will recognize that variations and modifications of the tree ladder of the present invention can be used without departing from the spirit and scope of the present invention.

From the foregoing description, it will be recognized by those skilled in the art that a lightweight and compact tree ladder has been provided.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A ladder comprising:
a hook segment having an outboard end including a receiver,
a first cable segment secured to said hook segment,
a second cable segment secured to said hook segment,
a plurality of elongated rungs including a bottom rung and at least an uppermost intermediate rung, each of said rungs including a first end section including a receiver and an opposed second end section including an extension adapted to releasably engage the receiver of an adjacent rung, said uppermost rung including an extension adapted to releasably engage said receiver of said hook segment
each of said first end sections of said rungs being secured to said first cable segment and each of said second end sections being secured to said second cable segment.

2. The apparatus of claim 1 further including a flexible cable secured to said hook segment adjacent to said outboard end.

3. The apparatus of claim 1 wherein the length of cable segments between adjacent rungs is greater than the lengths of the rungs.
